(19) United States
(12) Patent Application Publication
(10) Pub. No.: US 2024/0405482 A1
(43) Pub. Date: Dec. 5, 2024

(54) ELECTRICAL CABLE AND METHOD OF MANUFACTURING AN ELECTRICAL CABLE

(71) Applicant: Yazaki Europe Ltd., Basildon (GB)

(72) Inventors: Darko MARINAC, Zagreb (HR); Ante CAMBER, Zagreb (HR)

(73) Assignee: Yazaki Europe Ltd., Basildon (GB)

(21) Appl. No.: 18/677,134

(22) Filed: May 29, 2024

(30) Foreign Application Priority Data
Jun. 2, 2023 (EP) 23177085.0

(51) Int. Cl. H01R 13/6464; H01B 11/02; H01R 13/6463; H01R 43/28

(52) U.S. Cl. CPC H01R 13/6464; H01B 11/02; H01R 13/6463; H01R 43/28

(57) ABSTRACT

An electrical cable, in particular for data transmission, including: a pair of wires (1, 2) twisted together, each wire (1, 2) having a conductor (3, 4) covered with an insulator (5, 6), and a cable end section (7, 18, 20), along which the pair of wires (1, 2) is untwisted, wherein over a part of the cable end section (7, 18, 20) the insulators (5, 6) are removed from ends (8, 9) of the wires (1, 2), wherein the insulators (5, 6) of the pair of wires (1, 2) of the cable end section (7, 18, 20) are each covered with a layer of non-magnetic and electrically conductive material (14, 15).

### BACKGROUND OF THE INVENTION

### Field

The disclosure refers to an electrical cable, in particular for data transmission, comprising a pair of wires twisted together, each wire having a conductor covered with an insulator, and a cable end section, along which the pair of wires is untwisted, wherein over a part of the cable end section the insulators are removed from ends of the wires. Further, the disclosure refers to a method of manufacturing an electrical cable, in particular for data transmission, comprising the steps of providing a pair of wires each having a conductor covered with an insulator, twisting the pair of wires together, leaving the pair of wires untwisted along a cable end section, and removing the insulators from the conductors of ends of the wires over a portion of the cable end section.

### Background

Such an electrical cable and method for manufacturing same is described in US 2018/0035577 A1. Such twisted pair cables are typically intended to be inserted into connectors, which are provided for electrically connecting together two cables or for connecting at least one such cable to an electric circuit. To insert the individual wires of such cables into a housing of a connector, the wires of the cables have to be untwisted at their ends. In order to limit the transmission and reception of electromagnetic coupling between the wires and electromagnetically sensitive or interfering surrounding environment in this untwisted area, US 2018/0035577 A1 proposes jackets positioned around the untwisted wires at the ends. The jackets are made of electrically non-conductive material provided with magnetized particles oriented perpendicularly to the direction of the electric current flow in the cable.

In vehicles vast amount of data is generated and transmitted in order to implement various functions, such as advanced driver assistance systems (ADAS), on-board diagnostics, cameras and sensors, in-vehicle-infotainment systems, and smart safety systems. This requires in-vehicle networks that transfer data fast and reliable. A standard is automotive ethernet, which is cost-effective and lightweight and delivers data at high speeds. Unlike non-automotive ethernet, automotive ethernet cables are typically unshielded, single twisted pair, designed for lower weight and cost. Twisted pair cables are well known in the state of the art and widely used in different kinds of data transmitting architecture in which two conductors of a single circuit are twisted together for the purposes of improving electromagnetic compatibility. Compared to a single conductor or an untwisted balanced pair, a twisted pair reduces electromagnetic radiation from the pair and crosstalk between neighboring pairs and improves rejection of external electromagnetic interference.

When combining unshielded twisted pair cables with connectors to build an unshielded communication channel, problems may emerge. The standard 100BASE-T1 for ethernet connections with a data transfer rate of 100 Mbps requires a characteristic impedance along the entire communication channel of 100±10 ohms. The 1000BASE-T1 standard for a date transfer rate of 1,000 Mbps requires a characteristic impedance along the entire communication channel of 100±5 ohms. However, in order to connect the twisted pair of wires with a connector, a cable end section needs to be untwisted. This increases the characteristic impedance in the untwisted area.

### SUMMARY OF THE INVENTION

To provide a decreased characteristic impedance the electrical cable comprises a pair of wires twisted together, each wire having a conductor covered with an insulator, and a cable end section, along which the pair of wires is untwisted, wherein over a part of the cable end section the insulators are removed from ends of the wires, and wherein the insulators of the pair of wires of the cable end section are each covered with a layer of non-magnetic and electrically conductive material.

As a result of the layer of non-magnetic and electrically conductive material on the insulators of the pair of wires of the cable end section the parasitic capacitance is increased in this area, decreasing the characteristic impedance.

Any conductor has an inductance (L) per unit length. Further, any pair of conductors separated by an insulating medium creates capacitance (C) per unit length between those conductors. The characteristic impedance (Z₀) is a function of the inductance and the capacitance and is a very important parameter for any transmission line. As mentioned above, for typical automotive ethernet communication channels or transmission lines the characteristics impedance should be 100±10 or 5 ohms. For an ideal transmission line, the characteristic impedance is calculated by the formula:

$${Z}_{0} = \sqrt{\frac{L}{C}}$$

In order to reduce the characteristic impedance in the area of the untwisted pair of wires, the capacity in this area is increased by the layer of non-magnetic and electrically conductive material on the insulators.

As non-magnetic and electrically conductive material any kind of material with these properties can be used. The layer of non-magnetic and electrically conductive material can be, for instance, one of a compound, a fabric, a laminate, a sheet, a foil and a film with non-magnetic and electrically conductive components.

It has been shown that the use of graphene has balanced properties of parasitic capacitance and decreased characteristic impedance. Graphene is a single-atom-thick layer of carbon atoms arranged in a two-dimensional hexagonal lattice. Layers of graphene can be stacked on top of each other.

The length of the part of the pair of wires that is covered by a layer of non-magnetic and electrically conductive material may be less than 15 mm, in particular less than 10 mm or less than 5 mm.

The shorter the untwisted area length, the smaller the increase in the characteristic impedance and the greater the effectiveness of the parasitic capacitance created by non-magnetic and electrically conductive material applied onto the untwisted area to decrease the characteristic impedance.

In particular, each of the wires can be connected to an electrical terminal. The terminals may be attached to the wires by crimping, soldering or any other well known method. The terminals may be inserted into cavities of a connector housing.

The wires of the cable end section may be arranged in parallel to each other, at least along most of the length of the cable end section.

In an exemplary embodiment, the twisted pair of wires is covered with an insulating sheath, and the insulating sheath is removed from the cable end section. The electric cable may be unshielded, but is not limited to be unshielded.

The object is further achieved by a method of manufacturing an electrical cable, in particular for data transmission, comprising the steps of providing a pair of wires each having a conductor covered with an insulator, twisting the pair of wires together, leaving the pair of wires untwisted along a cable end section, and removing the insulators from the conductors of ends of the wires over a portion of the cable end section. A non-magnetic and electrically conductive material is applied to the insulators of the pair of wires of the cable end section.

The non-magnetic and electrically conductive material may be applied to the insulators by brushing, spraying, coating, laminating or wrapping or by arranging the non-magnetic and electrically conductive material in form of a tubular element onto the insulators.

### BRIEF DESCRIPTION OF THE DRAWINGS

An embodiment is described in more detail with respect to the attached drawings, wherein

FIG. 1 is a plan view of an electrical cable with terminals attached to the ends of the untwisted wires;

FIG. 2 is an enlarged view of the cable end section of the electric cable according to FIG. 1;

FIG. 3 is a side view of two electrical cables connected via a connector assembly;

FIG. 4 is a first diagram in which the characteristic impedance is plotted over length with a graphene layer of 5.5 mm in length;

FIG. 5 is a first diagram in which the characteristic impedance is plotted over length with a graphene layer of 10.5 mm in length; and

FIG. 6 is a first diagram in which the characteristic impedance is plotted over length with a graphene layer of 15.5 mm in length.

### DETAILED DESCRIPTION OF THE INVENTION

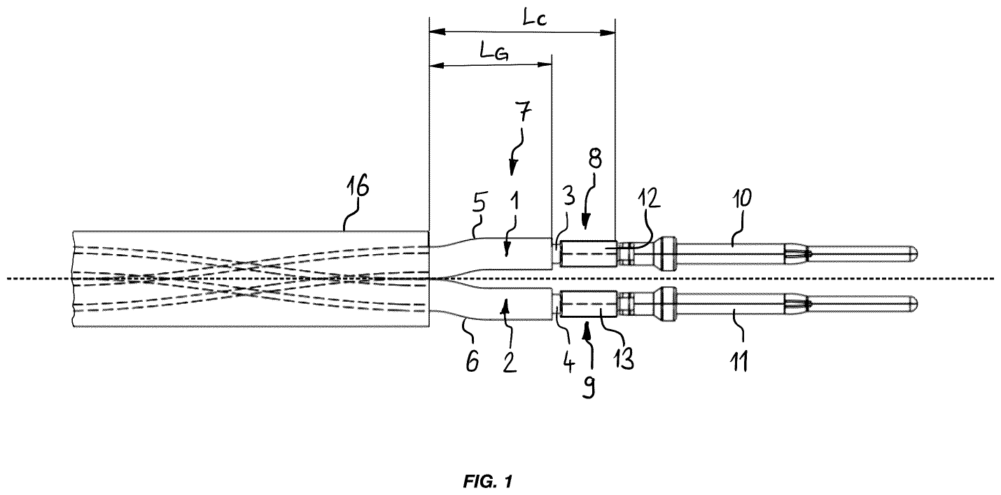

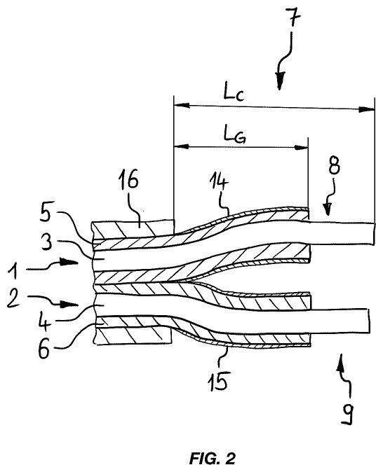

FIGS. 1 and 2 show an electrical cable in two different views and are described together. The electrical cable comprises a pair of wires 1, 2 twisted together. Each of the wires 1, 2 has a conductor 3, 4 and each conductor 3, 4 is covered with an insulator 5, 6. The conductors 3, 4 are made of an electrically conductive material, such as for instance copper. The insulators 5, 6 are made of an electrically insulating non-conductive material, such as plastic material, e.g. polyethylene (PE), polypropylene (PP), polyvinyl chloride (PVC), or rubber material.

The electrical cable has a cable end section 7. Along a length L_{C} of the cable end section 7 the pair of wires 1, 2 is untwisted. The wires 1, 2 may be left untwisted when twisting the wires 1, 2 or after twisting the wires 1, 2 the wires 1, 2 may be untwisted along the cable end section 7. The untwisted wires 1, 2 are arranged in parallel to each other, at least over a part of the cable end section 7.

Over a part of the cable end section 7 the insulators 5, 6 are removed from ends 8, 9 of the untwisted wires 1, 2. The uninsulated ends 8, 9 of the wires 1, 2 expose the conductors 3, 4 that are connected to terminals 10, 11. In the shown embodiment, the terminals 10, 11 are crimped to the conductors 3, 4 via crimping portions 12, 13 of the terminals 10, 11.

The insulators 5, 6 of the pair of wires 1, 2 of the cable end section 7 are each covered by a layer of non-magnetic and electrically conductive material 14, 15. The layer of non-magnetic and electrically conductive material 14, 15 can be made of graphene. The layer of non-magnetic and electrically conductive material 14, 15 can be applied to the insulators 5, 6 by brushing, spraying, coating, laminating or wrapping or by arranging the non-magnetic and electrically conductive material in form of a tubular element onto the insulators 5, 6.

A length L_{G} of the part of the pair of wires 1, 2 that is covered with the layer of non-magnetic and electrically conductive material 14, 15 is less than 15 mm, in particular less than 10 mm or less than 5 mm.

In the shown embodiment, the twisted pair of wires 1, 2 is covered with an insulating sheath 16. The insulating sheath 16 is made of an electrically insulating non-conductive material, such as plastic material, e.g. polyethylene (PE), polypropylene (PP), polyvinyl chloride (PVC), or rubber material. The insulating sheath 16 is removed from the cable end section 7. In another embodiment, the electrical cable may comprise more than one twisted pair of wires 1, 2 that are all covered by the insulating sheath 16.

In the shown embodiment the electrical cable is unshielded but may also be provided as shielded cable.

For manufacturing the above describe electrical cable a pair of wires 1, 2 each having a conductor 3, 4 covered with an insulator 5, 6 are provided. The wires 1, 2 are twisted together, leaving the pair of wires 1, 2 untwisted along the cable end section 7. Alternatively, the twisted pair of wires 1, 2 is untwisted along the cable end section 7 at a later stage. The insulators 5, 6 are removed from the conductors 3, 4 of ends 8, 9 of the wires 1, 2 at a portion of the cable end section 7. Finally, the layer of non-magnetic and electrically conductive material 14, 15 is applied onto the insulators 5, 6 of the untwisted part of the pair of wires 1, 2 of the cable end section 7.

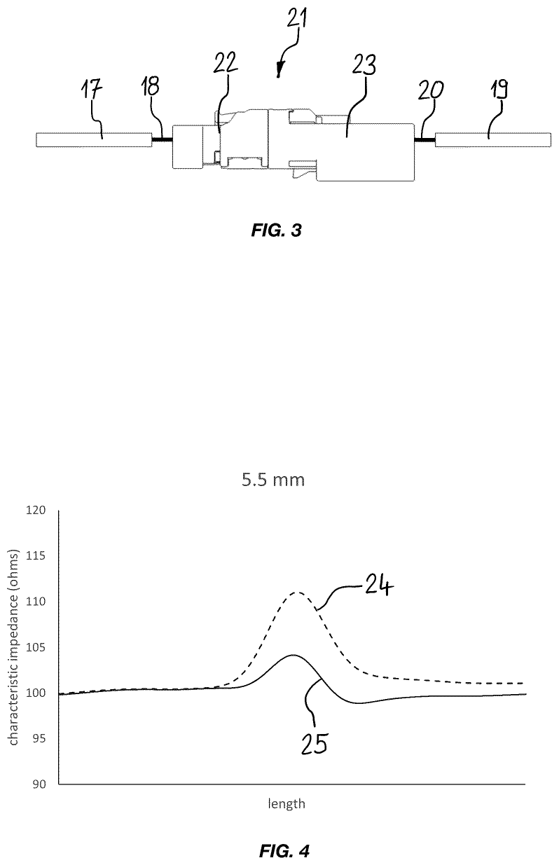

FIG. 3 discloses a first electric cable 17 having a first cable end section 18, which is connected via a connector assembly 21 to a second cable end section 20 of a second electric cable 19. The connector assembly 21 comprises a first connector 22, which is connected to the first cable end section 18, and a second connector 23, which is connected to the second cable end section 19. An untwisted pair of wires of the first cable end section 18, as described in connection with FIGS. 1 and 2, is arranged within the first connector 22. A further untwisted pair of wires of the second cable end section 20, also as described in connection with FIGS. 1 and 2, is arranged within the second connector 23. The two connectors 22, 23 are mechanically mated so that terminals attached to the wires of the first cable end section 18 and terminals attached to the wires of the second cable end section 20 are electrically connected.

FIG. 4 is a diagram plotting the characteristic impedance in ohms on the Y-axis against the length of the arrangement, as shown in FIG. 3, on the X-axis.

A first measurement curve 24 represents the measurement of impedance of the first electric cable, the second electric cable and the connectors of the arrangement as shown in FIG. 3 wherein the insulators of the wires of the cable end sections are not coated with a layer of non-magnetic and electrically conductive material.

A second measurement curve 25 represents the measurement for the arrangement as shown in FIG. 3, in which each insulator of the wires of the first cable end section and the second cable end section coated with a layer of non-magnetic and electrically conductive material, e.g. graphene, over a length L_{G} of 5.5 mm. The wires used have a characteristic impedance of 100 ohms.

It can be seen, that without using a layer of non-magnetic and electrically conductive material in the area of the untwisted pair of wires the characteristic impedance rises and exceeds 110 ohms, thereby exceeding the limit for the use in an automotive ethernet for a data transfer rate of both 1,000 Mbps and 100 Mbps.

By applying a layer of non-magnetic and electrically conductive material onto the insulators of the untwisted wires, wherein the length of the untwisted and covered wires is 5.5 mm, the maximum characteristic impedance could be reduced by approximately 7 ohms reaching a value below 105 ohms. This arrangement meets the requirements for automotive ethernet for a data transfer rate of 1,000 Mbps and 100 Mbps.

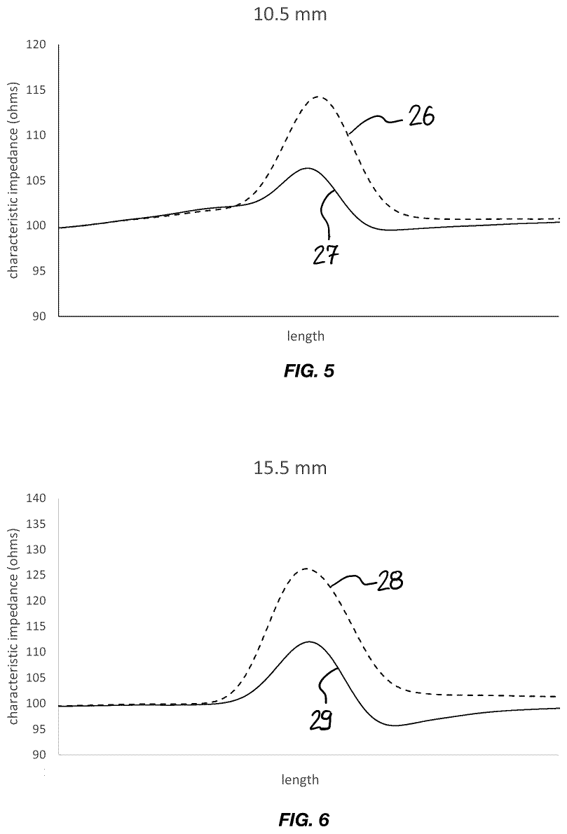

FIG. 5 is a diagram as shown in FIG. 4 comparing the measurements of the characteristic impedance of cables with and without a layer of non-magnetic and electrically conductive material, e.g. graphene, on an untwisted part of the pair of wires.

The first measurement curve 24 in dashed line represents the measurement of the impedance of an electric cable without a layer of non-magnetic and electrically conductive material applied to the insulators of the wires of the cable end section.

The second measurement curve 25 shows the measurement for the arrangement shown in FIG. 3, in which each insulator of the wires of the first cable end section and the second cable end section is provided with a layer of non-magnetic and electrically conductive material, e.g. graphene, over a length L_{G} of 10.5 mm. The wires used have a characteristic impedance of 100 ohms.

It can be seen, that without using a layer of non-magnetic and electrically conductive material in the area of the untwisted pair of wires the characteristic impedance rises to approximately 114 ohms, thereby exceeding the limit for the use in an automotive ethernet for a data transfer rate of both 1,000 Mbps and 100 Mbps.

By applying a layer of non-magnetic and electrically conductive material onto the insulators of the untwisted wires, wherein the length of the untwisted and coated wires is 10.5 mm, the maximum characteristic impedance could be reduced by approximately 7 ohms reaching a value between 106 and 107 ohms. This arrangement meets the requirements for automotive ethernet for a data transfer rate of 100 Mbps.

If a cable with a characteristic impedance of 95 to 98 ohms were used, instead of a cable with a characteristic impedance of 100 ohms as shown in FIG. 5, the maximum characteristic impedance would be below 105 ohms and would also meet the requirements for automotive ethernet for a data transfer rate of 1,000 Mbps.

FIG. 6 is a diagram as shown in FIG. 4 comparing the measurements of the characteristic impedance of cables with and without a layer of non-magnetic and electrically conductive material, e.g. graphene, on an untwisted part of the pair of wires.

The first measurement curve 26 in dashed line represents the measurement of the impedance of an electric cable without a layer of non-magnetic and electrically conductive material applied to the insulators of the wires of the cable end section.

The second measurement curve 27 shows the measurement for the arrangement shown in FIG. 3, in which each insulator of the wires of the first cable end section and the second cable end section is provided with a layer of non-magnetic and electrically conductive material, e.g. graphene, over a length L_{G} of 15.5 mm. The wires used have a characteristic impedance of 100 ohms.

It can be seen, that without using a layer of non-magnetic and electrically conductive material in the area of the untwisted pair of wires the characteristic impedance rises to more than 125 ohms, thereby exceeding the limit for the use in an automotive ethernet for a data transfer rate of both 1,000 Mbps and 100 Mbps.

By applying a layer of non-magnetic and electrically conductive material onto the insulators of the untwisted wires, wherein the length of the untwisted and covered wires is 15.5 mm, the maximum characteristic impedance has been reduced by approximately 14 ohms reaching a value of approximately 112 ohms. In certain areas, the characteristic impedance drops to just above 95 ohms. This arrangement would still not meet the requirements for automotive ethernet, either for a data transfer rate of both 1,000 Mbps nor 100 Mbps.

However, if a cable with a characteristic impedance of 95 to 98 ohms were used, instead of a cable with a characteristic impedance of 100 ohms as shown in FIG. 6, the maximum characteristic impedance would be below 110 ohms and would not drop below 90 ohms. This would meet the requirements for automotive ethernet for a data transfer rate of 100 Mbps.

### REFERENCE NUMERALS

1 wire
2 wire
3 conductor
4 conductor
5 insulator
6 insulator
7 cable end section
8 end of wire
9 end of wire
10 terminal
11 terminal
12 crimping portion
13 crimping portion
14 layer of non-magnetic and electrically conductive material
15 layer of non-magnetic and electrically conductive material
16 insulating sheath
17 first electrical cable
18 first cable end section
19 second electrical cable
20 second cable end section
21 connector assembly
22 first connector
23 second connector
24 first measurement curve
25 second measurement curve
26 first measurement curve
27 second measurement curve
28 first measurement curve
29 second measurement curve
C capacitance
L inductance
L_{C} length of the cable end section
L_{G} length of the layer of non-magnetic and electrically conductive material
Z₀ characteristic impedance

1. An electrical cable, in particular for data transmission, comprising:
a pair of wires twisted together, each wire having a conductor covered with an insulator, and
a cable end section, along which the pair of wires is untwisted, wherein over a part of the cable end section the insulators are removed from ends of the wires, wherein the insulators of the pair of wires of the cable end section are each covered with a layer of non-magnetic and electrically conductive material.

2. The electrical cable according to claim 1 wherein the layer of non-magnetic and electrically conductive material is one of a compound, a fabric, a laminate, a sheet, a foil and a film with non-magnetic and electrically conductive components.

3. The electrical cable according to claim 1 wherein the layer of non-magnetic and electrically conductive material is made of graphene.

4. The electrical cable according to claim 1 wherein the length of the part of the pair of wires that is covered by a layer of non-magnetic and electrically conductive material is less than 15 mm, in particular less than 10 mm or less than 5 mm.

5. The electrical cable according to claim 1 wherein each of the wires is connected to an electrical terminal.

6. The electrical cable according to claim 5 wherein the terminals are arranged in a connector housing.

7. The electrical cable according to claim 1 wherein the wires of the cable end section are arranged in parallel to each other.

8. The electrical cable according to claim 1 wherein the twisted pair of wires is covered with an insulating sheath, and
wherein the insulating sheath is removed from the cable end section.

9. The electrical cable according to claim 1 wherein the electrical cable is unshielded.

10. A method of manufacturing an electrical cable, in particular for data transmission, comprising the steps of:
providing a pair of wires each having a conductor covered with an insulator, twisting the pair of wires together, leaving the pair of wires untwisted along a cable end section,
removing the insulators from the conductors of ends of the wires over a portion of the cable end section, and
applying a layer of non-magnetic and electrically conductive material onto the insulators of the pair of wires of the cable end section.

11. The method according to claim 10 wherein the non-magnetic and electrically conductive material is applied to the insulators by brushing, spraying, coating, laminating or wrapping or by arranging the non-magnetic and electrically conductive material in form of a tubular element onto the insulators.
